(19) United States
(12) Patent Application Publication
(10) Pub. No.: US 2018/0340813 A1
(43) Pub. Date: Nov. 29, 2018

(54) CRYOGENIC FLUID REPORTING SYSTEMS AND METHODS

(71) Applicants: Jason Cowles, Perris, CA (US); Rob Manchise, Brea, CA (US); Sam Iravantchi, Fountain Valley, CA (US); Travis Cochran, Fountain Valley, CA (US); Michael Palmer, Fountain Valley, CA (US)

(72) Inventors: Jason Cowles, Perris, CA (US); Rob Manchise, Brea, CA (US); Sam Iravantchi, Fountain Valley, CA (US); Travis Cochran, Fountain Valley, CA (US); Michael Palmer, Fountain Valley, CA (US)

(21) Appl. No.: 15/989,029

(22) Filed: May 24, 2018

Related U.S. Application Data
(60) Provisional application No. 62/511,251, filed on May 25, 2017.
(60) Provisional application No. 62/534,600, filed on Jul. 19, 2017.
(60) Provisional application No. 62/544,271, filed on Aug. 11, 2017.
(60) Provisional application No. 62/592,127, filed on Nov. 29, 2017.
(60) Provisional application No. 62/598,960, filed on Dec. 14, 2017.
(60) Provisional application No. 62/653,060, filed on Apr. 5, 2018.

(51) Int. Cl. G01F 23/20; F17C 13/02; F17C 13/08; B62B 3/10

(52) U.S. Cl. CPC G01F 23/20; F17C 13/028; F17C 13/085; B62B 3/104; F17C 2201/0104; F17C 2205/0161; B62B 2203/50; F17C 2223/0161; F17C 2250/0417; F17C 2250/0426; F17C 2250/0421; F17C 2270/02; F17C 2221/014

(57) ABSTRACT

Various cryogenic fluid reporting systems are disclosed. In some embodiments, the system comprises a cart with a base and a load cell. The base can receive and support a cryogenic fluid tank and the weight of the cryogenic fluid tank can be applied to the load cell. The cart can include a transmitter configured to transmit a signal indicative of the weight applied to the load cell. The system can include a receiver configured to receive the signal from the transmitter. The system can include a computing system in communication with the receiver. The computing system can include software configured to correlate the signal indicative of the weight of the cryogenic fluid tank to a fill amount of the tank.

### CROSS REFERENCE

The present application claims a priority benefit under 35 U.S.C. § 119 of U.S. Patent Application No. 62/511,251, filed May 25, 2017, U.S. Patent Application No. 62/534,600, filed Jul. 19, 2017, U.S. Patent Application No. 62/544,271, filed Aug. 11, 2017, U.S. Patent Application No. 62/592,127, filed Nov. 29, 2017, U.S. Patent Application No. 62/598,960, filed Dec. 14, 2017, and U.S. Patent Application No. 62/653,060, filed Apr. 5, 2018. The entirety of each of the aforementioned applications is hereby incorporated by reference herein.

### BACKGROUND

### Field

This disclosure relates to a system for monitoring and reporting levels of fluids, such as levels of cryogenic fluids in cylinders or other types of tanks.

### Certain Related Art

Tanks containing a liquid or gas are employed in many uses. For example, tanks can used to dispense nitrogen for inerting purposes and to dispense oxygen for medical use. Some tanks hold argon, helium, hydrogen, carbon dioxide, or other materials. Tanks that hold cryogenic liquids, such as liquid nitrogen or liquid oxygen, are called cryogenic tanks. Cryogenic tanks can include an inner vessel and an outer vessel with insulation and/or a vacuum in between. This can reduce heat transfer and reduce boil-off of the liquid stored in the cryogenic tank.

### SUMMARY OF CERTAIN FEATURES

A problem with cryogenic tanks is that it is difficult to determine the level of liquid in the tank. Such tanks are typically heavy, opaque, and contain a dangerous material (a liquid at cryogenic temperatures), which make it difficult or impossible for a user to discern the amount of liquid inside. One approach is to use a float, which is a piece of metal that floats at or near the surface of the liquid in the tank. The height of the float above the bottom of the tank can be detected and that height can be correlated to approximate the amount of liquid in the tank. However, this approach typically does not provide an accurate reading of the tank level. Inaccurate tank readings can be frustrating to distributors and users, such as customers. Users may complain that they cannot determine how full their tanks are at any given time. Users may even accuse a fluid or tank provider (e.g., a distributor) of cheating them on the level of cryogenic liquid in the tank. Indeed, maintaining the user's trust, and demonstrating that the cryogenic fluid provider is being honest in the amount being delivered to the user, can be particularly challenging in the context of cryogenic tanks.

Another approach uses an electronic impulse between two pieces of metal located inside the tank. For example, capacitive liquid level sensors can be used in which the cryogenic liquid completes a circuit and outputs a liquid level reading, such as to a computer or a gauge. This approach is inaccurate and can be manipulated by setting the empty and full levels at a user's discretion. Moreover, this approach, as well as the aforementioned float or other approaches that insert items into the tank, can damage the tank. For example, the inserted item can become cold-welded inside the tank.

Another problem associated with cryogenic tanks relates to the way such tanks are refilled. Conventionally, cryogenic liquid tanks are filled off-site (e.g., at a central filling facility) and then transported to the user's location. This is inefficient and problematic. For example, the tanks may have been filled days and weeks before delivery to the user, during which time substantial loss may have occurred. This short-changes users, who typically pay for the weight of the tank at the time of filling. With no scale available at the user location, there is no way the user can verify whether the fill level of the tank is correct. Moreover, laws may limit the amount by which a cryogenic tank can be filled and legally transported on roads. For example, laws may limit the tank to being filled to about 80% capacity, thereby precluding a tank that is more full from being delivered to a customer. Various embodiments are adapted to report current tank levels and/or the amount of usable liquid remaining in the tank.

The system of the present disclosure can address one or more of the above-identified concerns, or others. In some embodiments, the system can accurately determine the liquid level (e.g., volume) in the cryogenic tank. The system can do so without requiring the insertion of items into the tank. For example, several embodiments do not include inserting any measuring device inside the tank. In some embodiments, the system is configured to weigh the cryogenic tank and to determine, based on the weight, the amount of cryogenic liquid in the tank. In some embodiments, the system can include filling a cryogenic tank at a location of use, such as at customer's facility. In certain implementations, the system does not include transporting the tank to an off-site location for filling. In several implementations, the system includes refilling the tank at a customer's location.

In some embodiments, the system includes a cart. In some embodiments, the cart comprises a frame and a plurality of legs. The legs can comprise casters and/or wheels. The legs can be extendable, such as radially outward. The legs can be telescopically received in the frame. The cart can include a plate that the cryogenic tank rests on. The legs can extend radially outward of the plate. In some embodiments, the cart includes a handle, which can be removable. The cart can be rigidly constructed, such as from steel tubing. In some embodiments, the tubing has a generally rectangular (e.g., square) cross-sectional shape. In some embodiments, the tubing has a generally circular or other cross-sectional shape.

In certain implementations, the system includes a control unit, such as a server. The server can communicate with the cart, such as regarding the amount of liquid in the tank. The server can communicate such data to external computing devices, such as laptops, smartphones, etc. In some embodiments, the server can be configured to make scheduling decisions. Such decisions can be based on, for example, the level of the tank or tanks, geographic locations of the various deliveries, etc. The server can use the data to design a unique schedule based on those factors. In some embodiments, designing the schedule occurs automatically and/or without any interaction with or instruction from humans. The computer can run Monte Carlo simulations to optimize delivery truck routing based on pre-programmed criterion. Some embodiments of the system comprise automated scheduling and/or forecasting features.

Certain embodiments of the system are configured to address the risk and/or impact of transcription errors; address the risk of incorrect values reported whether due to customers, drivers, language barrier, misreading of gauges, etc.; track the number of tanks in service; predict surges in usage, such as through a forecasting model (e.g., based on past usage, economic conditions, etc.); track key performance indicators (KPI), such as in terms of fluid (e.g., liquefied nitrogen) usage and route and/or traffic efficiency (e.g., based on run, driver, truck, etc.); react quickly to customer requests, such as requests for an “emergency fill”; automatically design schedules and routes; address gaps in communication and reporting by drivers and operations staff; and/or determine profitability of delivery routes and/or customers.

The summary is illustrative only and is not intended to be limiting. Other aspects, features, and advantages of the systems, devices, and methods and/or other subject matter described in this application will become apparent in the teachings set forth below. The summary is provided to introduce a selection of some of the concepts of this disclosure. The summary is not intended to identify key or essential features of any subject matter described herein.

### BRIEF DESCRIPTION OF THE DRAWINGS

Various embodiments are depicted in the accompanying drawings for illustrative purposes, and should in no way be interpreted as limiting the scope of the embodiments. Various features of different disclosed embodiments can be combined to form additional embodiments, which are part of this disclosure.

FIG. 1 schematically illustrates an embodiment of a cryogenic fluid reporting system, including a cart.

FIG. 2A illustrates a perspective view of an embodiment of the cart of the system of FIG. 1, with a tank on the cart.

FIG. 2B illustrates a side cross-sectional view of the cart and tank of FIG. 2A.

FIGS. 2C and 2D illustrate perspective views of the cart of FIG. 2A with the tank not illustrated for purposes of presentation.

FIG. 2E illustrates a top view of the cart of FIG. 2A.

FIG. 2F illustrates a perspective view of a spring clip and hitch pin of a handle of the cart of FIG. 2A.

FIG. 3A illustrates a perspective view of another embodiment of the cart of the system of FIG. 1, with a tank on the cart.

FIG. 3B illustrates a bottom portion of the cart of FIG. 3A.

FIGS. 3C and 3D illustrate perspective views of the cart of FIG. 3A with the tank not illustrated for purposes of presentation.

FIG. 3E illustrates a perspective view of the cart of FIG. 3A with a portion of the cart shown as transparent for purposes of presentation.

FIG. 3F illustrates an exploded view of the cart of FIG. 3A.

FIG. 4A illustrates a perspective view of another embodiment of the cart of the system of FIG. 1, with a tank on the cart.

FIG. 4B illustrates a perspective view of the cart of FIG. 4A with the tank not illustrated for purposes of presentation.

FIG. 4C illustrates a perspective view of the cart of FIG. 4B with a tank support not illustrated for purposes of presentation.

FIG. 4D illustrates a side view of the cart of FIG. 4B.

FIG. 4E illustrates a close-up view of a portion of the cart of FIG. 4D.

FIG. 5 further illustrates components of the cryogenic fluid reporting system of FIG. 1.

FIGS. 6A-6C illustrate top, side, front, and rear views of a cryogenic fluid delivery vehicle.

FIGS. 7A-7C illustrate example graphical user interfaces that can be implemented with the system of FIG. 1.

### DETAILED DESCRIPTION OF CERTAIN EMBODIMENTS

The various features and advantages of the systems, devices, and methods of the technology described herein will become more fully apparent from the following description of the embodiments illustrated in the figures. These embodiments are intended to illustrate the principles of this disclosure, and this disclosure should not be limited to merely the illustrated examples. The features of the illustrated embodiments can be modified, combined, removed, and/or substituted as will be apparent to those of ordinary skill in the art upon consideration of the principles disclosed herein.

### Overview

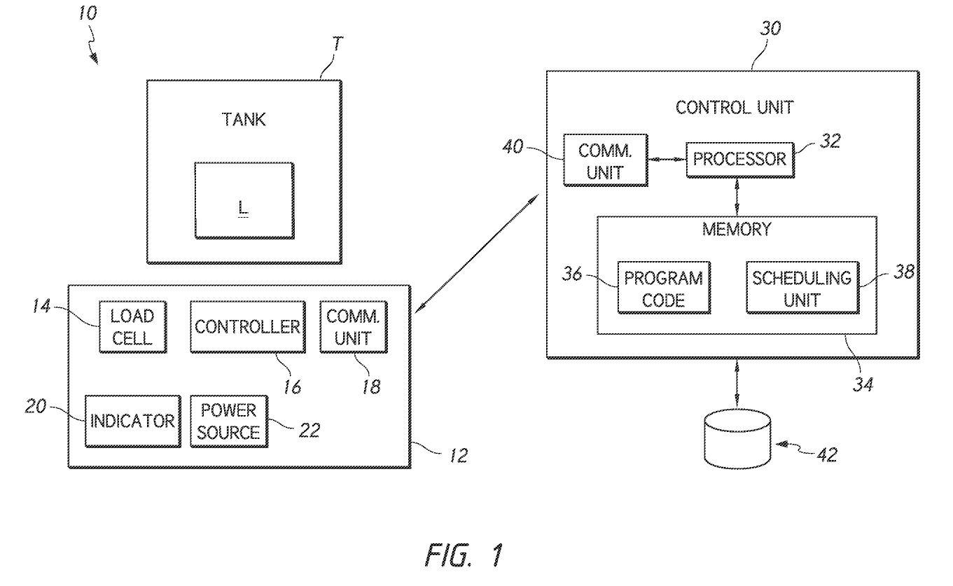

FIG. 1 illustrates an example embodiment of a cryogenic fluid reporting system 10. The system 10 can include a cart 12. The cart 12 can be configured to receive and/or support a cryogenic tank T. The cart 12 can include a load cell 14, which can measure the weight of the tank T. The cart 12 can include a controller 16, which can communicate with the load cell 14, such as by receiving a signal from the load cell 14 and determining, based on that signal, the weight of the tank T and/or the volume of cryogenic liquid L in the tank T. In some embodiments, the cart 12 includes a communication unit 18, such as a wireless router or wireless modem. The cart 12 can include an indicator 20, such as a dial, gauge, or display. The indicator 20 can display the amount of liquid L in the tank T. The cart 12 can include a power source 22, such as a battery.

The system 10 can include a control unit 30 that comprises one or more computing devices programmed with executable program code. For example, the control unit 30 can include a processor 32 coupled with a memory 34. The memory 34 includes the program code 36, which can be implemented on a computer-readable non-transitory medium. The processor 32 can execute the program code 36 to perform various operations, such as analyzing or making determinations data from the cart 12. In some embodiments, the control unit 30 comprises a server computing device. In several embodiments, the control unit 30 is located at an off-site location that is spaced apart from the location of the cart 12 and tank. The control unit 30 can comprise a central data processing facility. In some embodiments, the central processing facility schedules, dispatches, and/or is home to the trucks that travel to the tanks to refill the tanks. The control unit 30 can receive data from multiple carts related to multiple tanks.

In some embodiments, the control unit 30 includes a scheduling unit 38, which can be configured to determine a schedule delivery of cryogenic fluid, such as by a special delivery truck. The scheduling unit 38 can be implemented as an additional program module that runs on the control unit 30. Alternately, the scheduling unit 38 can be implemented on a separate computing device in communication with the control unit 30. The processor 32 can execute and/or communicate with the scheduling unit 38 to determine and/or receive scheduling information.

As shown, the control unit 30 can include a communication unit 40, such as a wireless router or wireless modem. In various implementations, the communication unit 40 comprises a transceiver. The communication unit 40 can be configured to interface with (e.g., send to and/or receive communications from) the communications unit 18 of the cart 12, such as via the internet. In various embodiments, the control unit 30 can include and/or be in communication with a storage system 42. The storage system 42, such as a database, can store data about the cart 12, tank, and other carts and tanks.

Cart

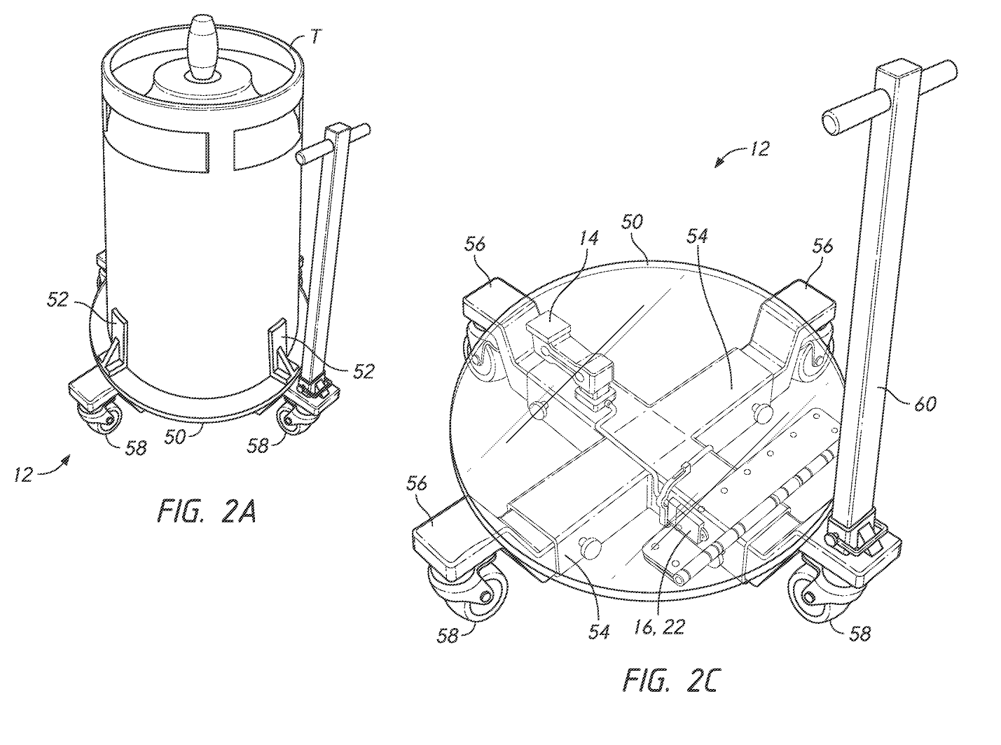

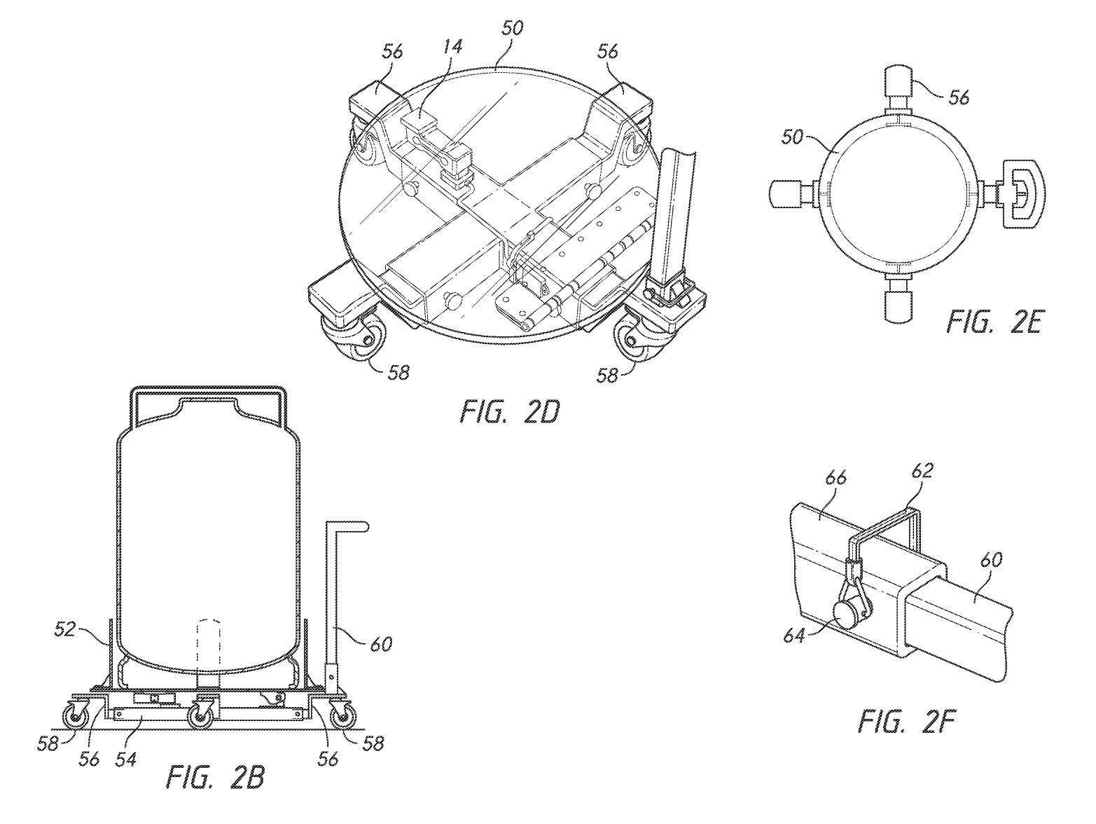

FIGS. 2A-2F illustrate an embodiment of the cart 12 of the system 10. The cart 12 can receive and support the cryogenic tank. For example, the tank can rest on the cart 12. The cart 12 can include one or more load cells 14, which can be positioned underneath the tank. Certain embodiments comprise 2, 3, 4, 5, 6, 7, or more load cells. The load cells 14 can be wired in parallel. The load cells 14 can accurately weigh the tank and can transmit such data to the controller 16, which can process and/or collect the data. The load cell 14 can be a single-point load cell or other type of load cell. The signal from the load cell 14 can comprise a voltage that corresponds to the detected weight. The controller 16 can comprise a load cell junction box and/or a summing box. As previously mentioned, the cart 12 can have an indicator 20 (such as a dial, gauge, display or otherwise) to tell a user how much cryogenic fluid is still available inside the tank. As shown, the controller 16 can be positioned apart from the load cells 14 and can be connected to the load cells 14 with conductors, such as wires.

The controller 16 can be powered by a power source 22, such as battery, solar panel, or otherwise. A power source 22 onboard the cart 12 enables the cart 12 to be used without the need to have any cords attached, which aids in portability. In some embodiments, the power source 22 comprises a hot-swappable battery which can facilitate battery replacement.

The cart 12 can include a base plate 50, on which the tank rests. The base plate 50 can include guides 52, which can act as lateral stabilizers and/or supports for the tank. As shown, in some embodiments, the guides 52 comprise generally vertically extending arms and/or flanges. In some embodiments, the guides 52 engage a sidewall of the tank. In several embodiments, the base plate 52 does not rigidly connect with the tank, such as with a bolt. This can facilitate removing the tank from the base plate 52 if needed. The base plate 50 can be hinged to enable the base plate 50 to move. This can enable the weight of the tank to be transferred to the load cell 14. In certain variants, such as is shown, the hinge is positioned opposite the load cell 14. In some implementations, the base plate 50 can hinge from a generally horizontal orientation to a generally vertical orientation. This can aid in storing the cart 12. In some embodiments, the base plate 50 is removable from the cart 12. For example, in some embodiments, the base plate 50 is held in place in the cart 12 by gravity only and/or is not secured with mechanical fasteners, such as bolts. Removing the base plate 50 can enable a different base plate to be installed. This can allow installation of a base plate 50 that generally corresponds to (e.g., is substantially equal to) the diameter of the tank. The cart 12 can receive base plates of different sizes so as to enable the cart 12 to receive various tank sizes (e.g., diameters). In some embodiments, the cart 12 is configured to stabilize the tank to inhibit or prevent the tank and/or the cart from tipping over. For example, the cart 12 can be linked together with other carts, such as with a hitch or u-shaped connector. Connecting multiple carts together can add to the stability of all of the tanks.

The cart 12 can include a frame 54. In some embodiments, the frame 54 comprises structural metal, such as square steel tubing. The frame 54 can include legs 56. As shown, in some embodiments, the legs 56 telescope. As shown, the frame 54 can extend below the base plate 50 and the tank. As shown, in some embodiments, the load cell 14 is spaced apart from the power source 22 and/or the controller 16, such as the load cell 14 being on a rear portion of the frame 54 and the power source 22 and/or controller 16 being on a front portion of the frame 54. In several embodiments, the base plate 52 can be removed from the frame without any tools. In certain implementations, the load cell 14 is positioned between the frame 54 and the base plate 52.

As illustrated, the cart 12 can have one or more wheels 58, such as caster wheels. The caster wheels can swivel 360°. The wheels 58 can be connected to the base plate 50 and/or the frame 54, such as to the legs 56. In some embodiments, the wheels 58 are connected directly to the tank. The embodiment shown has four wheels but more or fewer wheels are contemplated, such as 1, 2, 3, 5, 6 or more wheels. Some embodiments have no wheels. As shown, the wheels 58 can be positioned radially outward of the tank. This can increase the stability of the cart 12 and/or allow the tank to be positioned lower to the ground than if the wheels were underneath the tank.

In certain embodiments, one or more of the wheels 58 includes the load cell 14. When the tank is placed on the caster, the load cell 14 in the wheel 58 can detect the tank's weight. In some embodiments, the wheel 58 comprises the weight modules of, or any other features described in U.S. Pat. No. 5,823,278, filed Jun. 6, 1995, the entirety of which is hereby incorporated by reference herein.

In some implementations, the cart 12 comprises a handle 60. The handle 60 can be used to move the cart 12 to a desired location. In some embodiments, the handle 60 is configured to be removed from the cart 12. For example, the handle 60 can include a spring clip 62 and hitch pin 64 that connect with the handle 60 and/or the frame 54 of the cart 12. By removing the hitch pin 64, the handle 60 can be slid-out of a mounting point 66 of the cart 12, thereby allowing the handle 60 to be separated from the cart 12. This can reduce the size of the cart 12 and enable the cart 12 to be positioned in a smaller space and/or more tightly nested with other carts. Removal of the handle 60 can also reduce the chance of the tank being stolen or moved to an undesired location.

In some situations, the cart 12 is positioned on a floor that is tilted (e.g., not be perfectly level with horizontal). This can lead to an incorrect weight being sensed by the load cells 14. In some embodiments, the cart 12 is configured to detect such a floor tilt condition and/or to adjust for such errors. Some embodiments perform such detections and/or adjustments based on variations of the weight detected by the different wheels 58. For example, in an embodiment with four wheels, with two of the wheels on a lower end of a portion of a tilted floor and two wheels on an upper end of the portion of the tilted floor, the cart 12 can detect that the lower wheels are reading a different weight than the upper wheels. In some embodiments, the system 10 can determine the correct weight of the tank in spite of the tank being positioned on a tilted floor. Some embodiments perform such a determination based on the positions of the wheels and the weight detected by each of the wheels. Certain embodiments of the system 10 include an accelerometer or other sensor to detect a tilt. In some embodiments, the wheels 58 comprise self-leveling casters, which can automatically level the tank.

When the tank is positioned on a tilted floor, this can cause the tank to tilt relative to horizontal, which can increase the chance of the tank falling over. Certain embodiments of the system are configured to determine the tilt angle of the tank. For example, some embodiments detect the tilt angle of the tank based on the position and difference in weight readings of the various casters. In certain implementations, the system can issue an alarm in response to the tilt angle being greater than or equal to at least about: 0.5°, 1°, 2°, 3°, 5°, or other angles. For example, the system 10 can trigger a visual or audible alarm.

In some variants, the cart 12 can determine a center of gravity of the tank, such as based on the weight detected by the load cells 14 and certain tank characteristics (e.g., diameter, height, volume, etc.) that can be detected by or input into the system 10. In certain implementations, the permissible tilt angle of the tank varies as a function of the position of the center of gravity. For example, the permissible tilt angle can increase as the elevation of the center of gravity decreases.

In certain implementations, the tank is installed onto the cart 12 with a lifting system, such as a tripod or gantry. The lifting system can lift the tank into the air and/or onto the cart 12. The lifting system can be lightweight and portable. The lifting system can have a pulley system to raise the tank generally vertically so that the tank can be lowered down onto the cart 12.

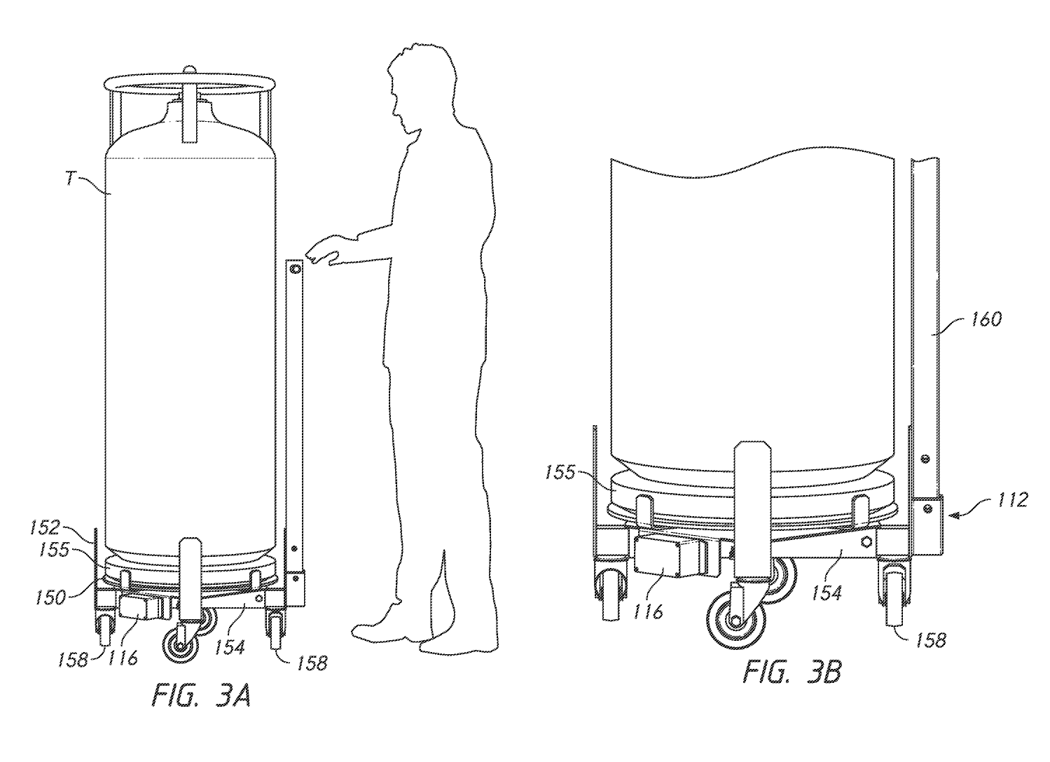

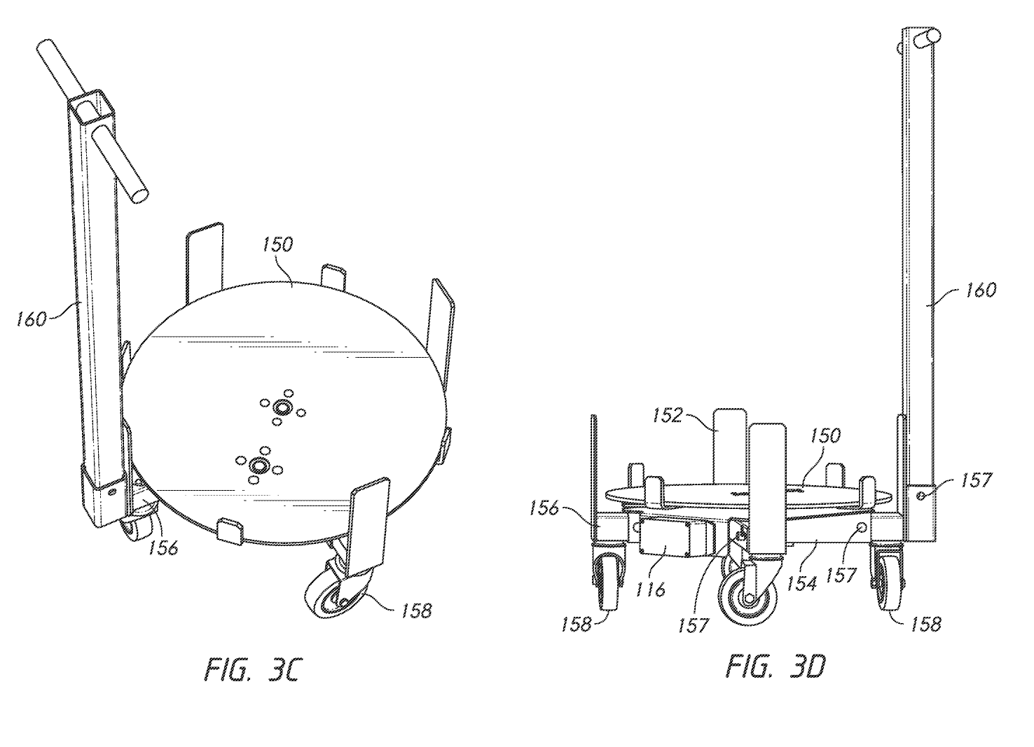

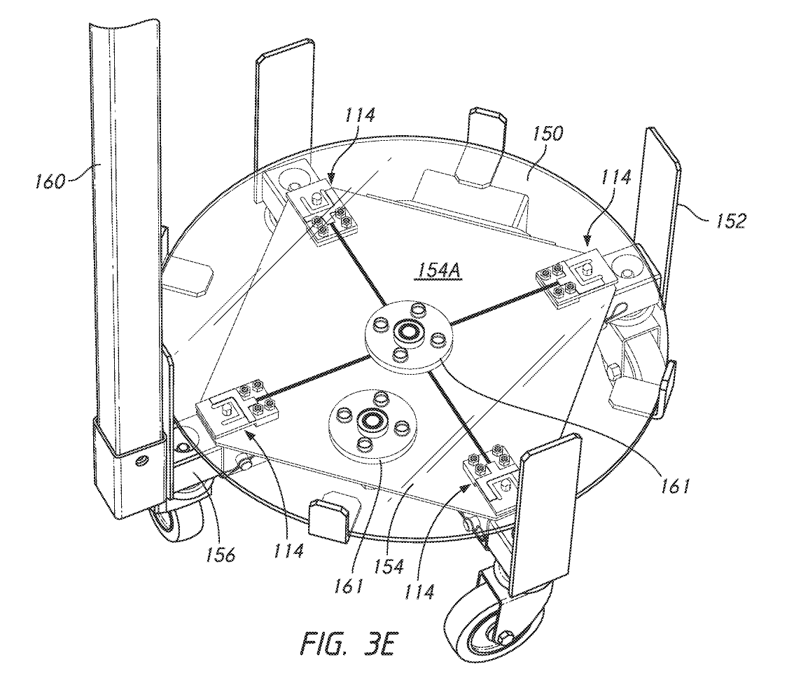

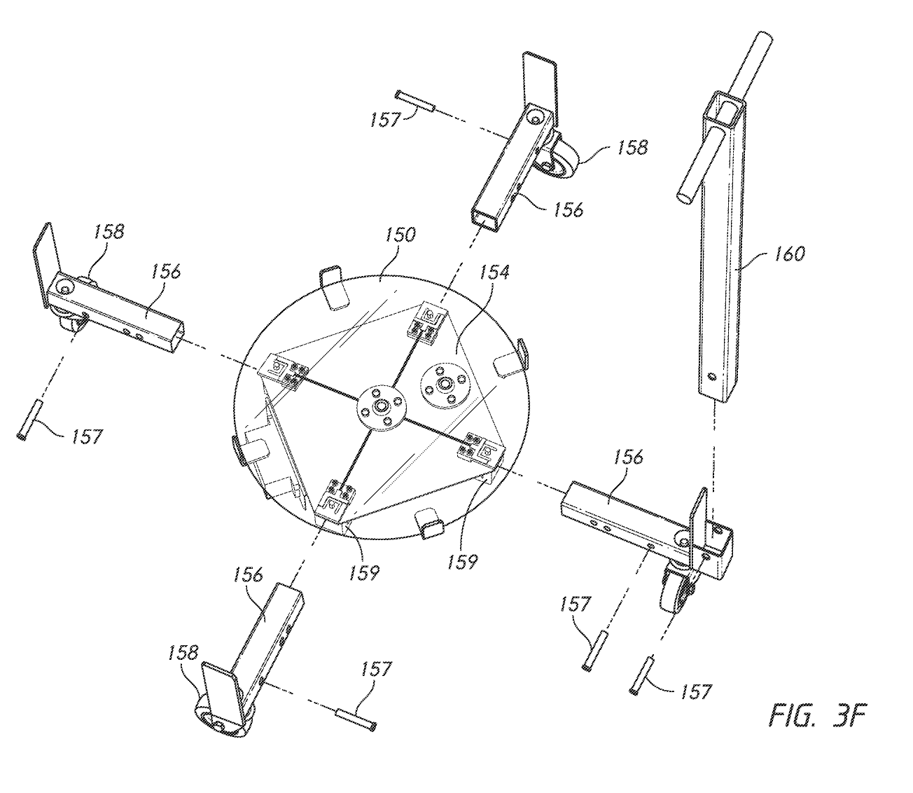

FIGS. 3A-3F illustrate another embodiment of a cart 112. The cart 112 can include any of the features of the cart 12. Accordingly, the reference numerals of the cart 112 are incremented by a factor of one hundred to identify features that are similar or identical to features of the cart 12. As shown, the cart 112 can include a base plate 150, guides 152, frame 154, legs 156, wheels 158, and handle 160. A controller 116 and/or power source can be positioned in a protective enclosure.

In certain variants, the cart 112 includes a tank support 155. As shown in FIGS. 3A and 3B, the tank support 155 can be positioned between the base plate 150 and the tank. As shown, the tank support can comprise a generally flat member, such as a plate, disk, or otherwise.

In certain embodiments, the cart 112 includes extendable legs 156. For example, as shown in FIG. 3C and 3D, the cart 112 can have legs 156 that extend and/or retract radially. The legs 156 can be secured with one or more pins 157 or other locking mechanisms. In some variants, the handle 160 is secured with a pin 157 to the frame 154 and/or a leg 156. In some implementations, the wheels 158 are positioned at the ends of the legs 156. In certain variants, the wheels 158 are located under the base plate 150. This can reduce the footprint of the cart 112 and/or can reduce the chance of the wheels 158 becoming a trip hazard. The cart 112 can be closely nested with other carts, such as in a manner similar to six-pack container packaging. Some embodiments include removable extension wheels (not shown). The extension wheels can be positioned on the same side or opposite to the handle 160. The extension wheels can provide support, such as in the process of moving in and out of buildings and through parking lots. In some embodiments, the handle 160 is connected with and/or a part of the removable extension wheel, which can reduce or avoid the handle being in the way.

As illustrated in FIG. 3E, in some embodiments, the cart 112 includes multiple load cells 114, such as 2, 3, 4, 5, or more. Using multiple load cells 114 can help to distribute and/or even out the weight distribution. This can reduce and/or minimize the pressure on any one load cell. As shown, the frame 154 can include a plate element 154A. In some embodiments, the load cells 114 are mounted on a top side of the plate element 154A. In some variants, the load cells 114 are mounted on an underside the plate element 154A. The plate element 154A can have the same or a different shape compared to the base plate 150. For example, as illustrated, the plate element 154A can be generally rectangular (e.g., square) and the base plate 150 can be generally circular.

In some embodiments, the cart 112 includes one or more guide elements 161. In some embodiments, the guide elements 161 comprise shafts. In certain embodiments, the guide elements 161 comprise flanges. The guide elements 161 can be spring loaded. The guide elements 161 can help give the platform a stabilized pivot point or cushion. In some embodiments, the guide elements 161 are configured to move up and down in small increments. In certain variants, the tank support 155 is configured to move along the guide elements 161 and relative to the base plate 150. In several embodiments, the entire weight of the tank support 155 and the tank rests on and/or is transferred through the load cells 114. In some implementations, the guide elements 161 can allow for changing of the base plate depending on what size tank is being used.

as shown in FIG. 3F, in some embodiments, the legs 156 and/or wheels 158 can be removed from the frame 154. The frame 154 can include receivers 159 that receive the legs 156. The pins 157 can secure the legs 156 in the receivers 159.

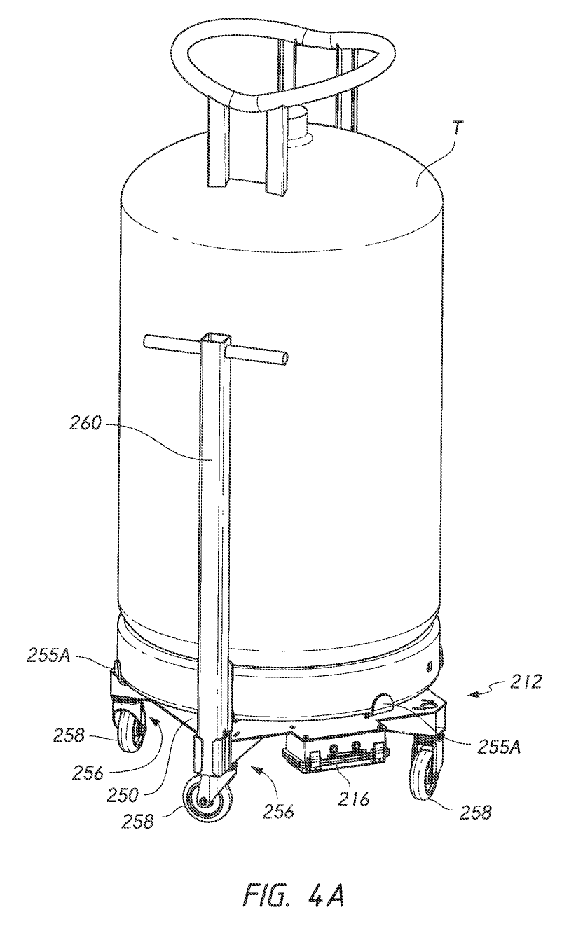

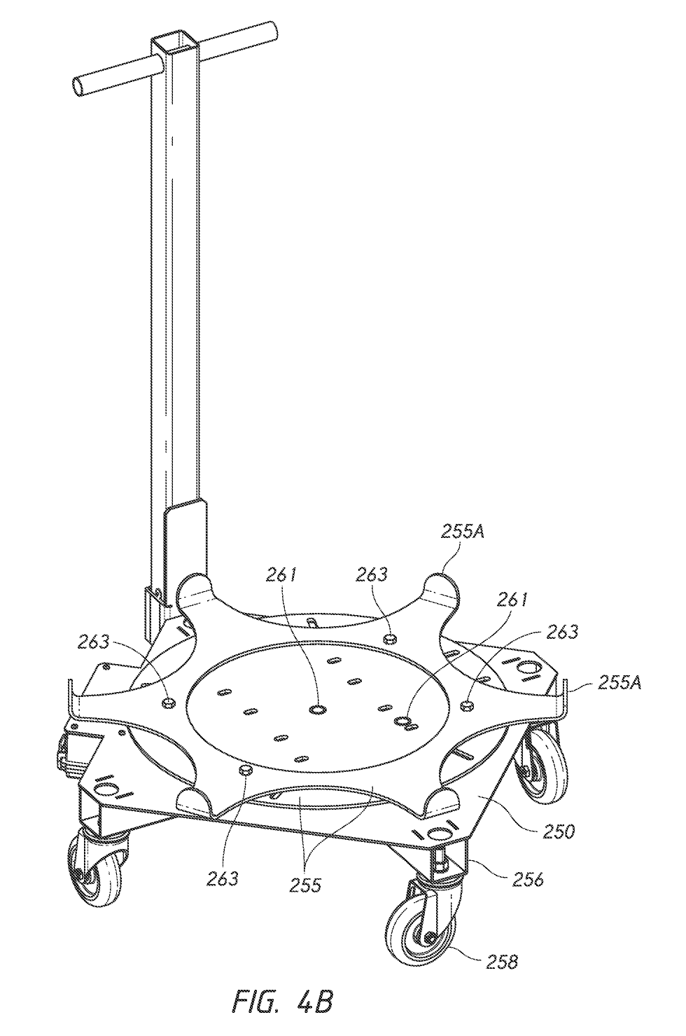

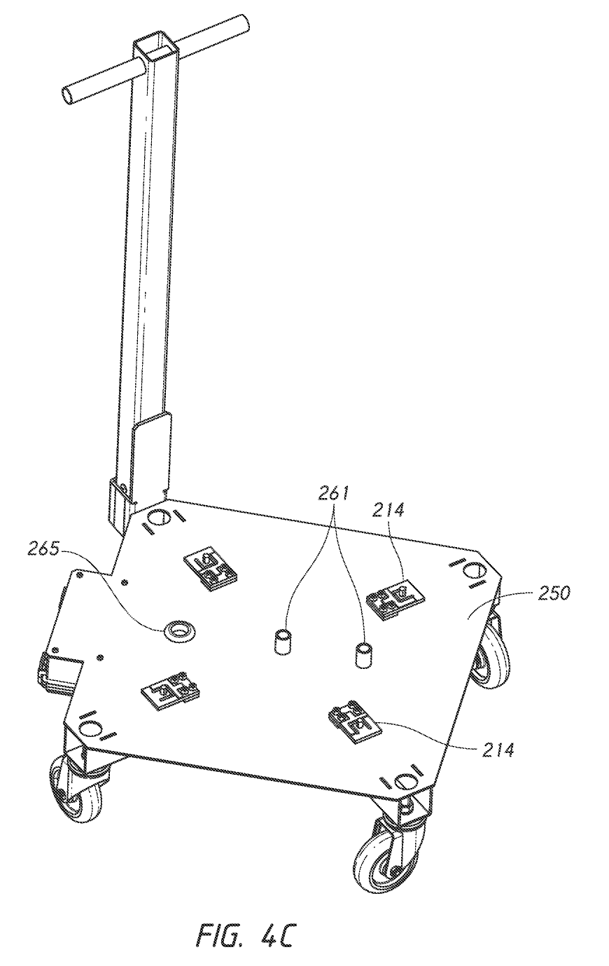

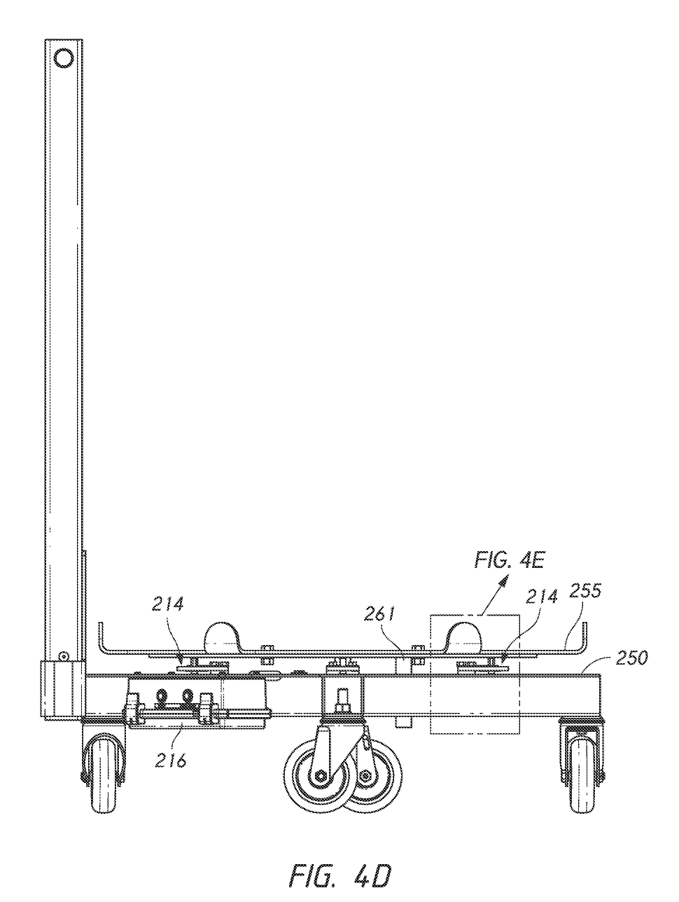

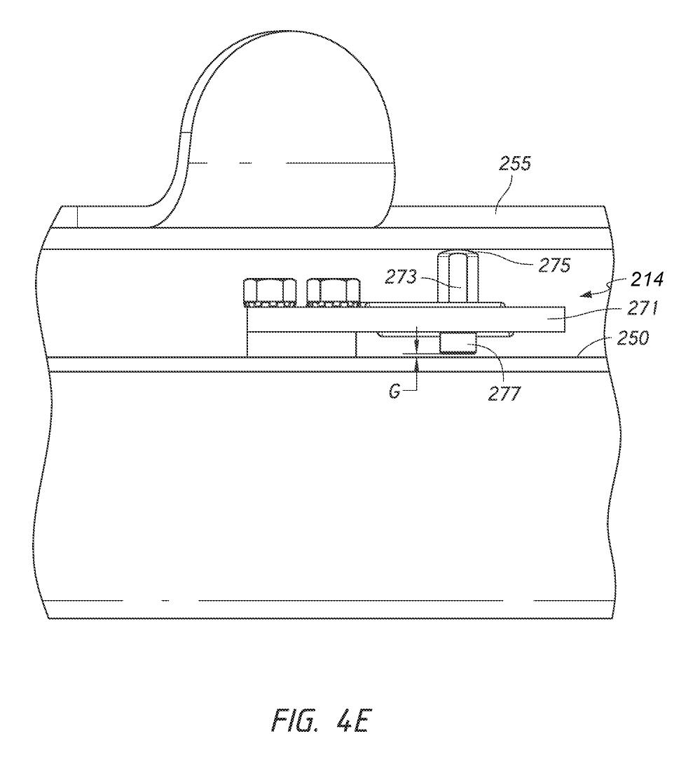

FIGS. 4A-4E illustrate another embodiment of a cart 212. The cart 212 can include any of the features of the cart 12 and/or the cart 112. As shown, the cart 212 can include a base plate 250, legs 256, wheels 258, and handle 260. A controller 216 and/or power source can be positioned in a protective enclosure.

The tank can be positioned on a tank support 255, such as a generally flat plate. As shown in FIGS. 4A and 4B, the tank support 255 can have radially outward arms with fingers 255A. The fingers can aid in positioning the tank on the tank support 255.

In some embodiments, the cart 212 includes one or more guide elements 261, such as shafts. The guide elements 261 can extend generally vertically between the base plate 250 and the tank support 255. For example, the tank support 255 can include openings that receive the guide elements 261. In certain variants, the tank support 255 is configured to move along the guide elements 261 and relative to the base plate 250. In several embodiments, the entire weight of the tank support 255 and the tank rests on and/or is transferred through the load cells 214. Certain embodiments comprise a biasing member (e.g., a spring) that biases the tank support 255 and the base plate 250 apart, such as in a generally vertical direction. In some embodiments, the guide elements 261 comprise tubing welded or otherwise secured to the base plate 250. In some embodiments, the guide elements 261 facilitate locating the tank support 255 and/or the tank relative to the load cells 214. For example, the guide elements 261 can substantially center the tank relative to the load cells 214, which can increase weight measurement accuracy.

In various embodiments, the guide elements 261 provide location and/or orientation control of the tank support 255 relative to the base plate 250. For example, the guide elements 261 can be asymmetrically positioned (e.g., radially and/or circumferentially). This can make it so that the tank support 255 will only receive the guide elements 261 in one radial and/or circumferential orientation of the tank support 255 relative to the base plate 250.

In some implementations, the guide elements 261 inhibit or prevent the tank support 255 from rotating relative to the base plate 250. For example, a physical interference between the guide elements 261 and the tank support 255 can impede the tank support 255 from rotating. Reducing rotation of the tank support 255 can be beneficial since such rotation can reduce the accuracy of the measured weight, for example, by applying an unwanted shear force to the load cells rather than a purely normal force.

As shown in FIG. 4B, some embodiments include tank leveling features 263. Some tanks have a bottom that is flat and/or not level. For example, the tank bottom may have dents or other damage. Mounting a tank with a bottom that is flat and/or not level can be a challenge, since the tank may have a tendency to tilt and/or wobble. Some embodiments are configured to compensate for such problematic tank bottoms with the tank leveling features 263. In certain implementations, the tank leveling features 263 comprise a plurality of screws, such as set screws. The screws can be threadably received in corresponding threaded holes (e.g., nuts) on the tank support 255 or the base plate 250. The screws can be rotated to extend or decrease the amount of the screw that protrudes above the surface of the tank support 255. This can enable a user to adjust the regions of contact between the tank support 255 and the tank in order to compensate for a bottom of the tank that is not flat and/or not level. In various embodiments, the tank leveling features 263 are spaced apart from and/or are not positioned directly over the load cells 214. The embodiment illustrated includes 4 tank leveling features 263, though other numbers are contemplated as well, such as 3, 5, 6, or more.

FIG. 4C illustrates the cart 212 with the tank and tank support hidden for purposes of presentation. As shown, the cart 212 can include a plurality of load cells, such as 3, 4, 5, 6, or more. The base plate 250 can include an aperture to permit wires (not shown) to extend between the controller 216 and the load cells 214.

As illustrated in FIGS. 4D and 4E, the load cells 214 can be mounted to the base plate 250, such as with fasteners (e.g., screws) as shown. The load cells 214 can be positioned under the tank support 255. As shown, the load cell 214 can comprise a cantilevered member 271. In some embodiments, deflection of the cantilevered member 271 is applied to a strain gauge or other measurement device, which can be output as a signal (e.g., a voltage) indicative of the measured weight.

The load cell 214 can include an upper support member 273, such as a pin. The upper support member 273 can include an upper end 275 that contacts the tank support 255. In some embodiments, the upper end 275 is tapered, such as being generally hemispherical, generally conical, or otherwise. This can reduce the surface area of contact between the upper support member 273 and the tank support 255. Reducing such surface area can decrease the chance and/or magnitude of a shear force (e.g., from rotation of the tank support 255) being transmitted to the load cell 214. Reducing or avoiding the application of shear force to the load cell 214 can increase accuracy of the weight measurement.

The load cell 214 can include a lower support member 277, such as a boss, screw head, or otherwise. As shown, the lower support member 277 can be spaced apart from the base plate 250 by a gap G. In some embodiments, the gap G is less than or equal to about: 1.0 mm, 0.75 mm, 0.50 mm, or otherwise. In some embodiments, the gap G comprises an air gap, void, or otherwise.

When a weight is applied to the tank support 255, the weight can be transferred through the upper support member 273 to the cantilevered member 271. This can deflect the cantilevered member 271 an amount that corresponds to the applied weight and the load cell 214 can output a corresponding signal (e.g., voltage). The lower support member 277 can limit the amount of deflection of the cantilevered member 271. For example, the deflection can be limited to the amount of the gap G before the lower support member 277 contacts the base plate 250. This can provide overload protection to the load cell 214. For example, if a tank that is too heavy is installed on the cart 212, the weight applied to the load cell 214 can be more than the allowable weight that the load cell is designed to withstand, which could damage the load cell 214. As another example, in the situation in which a tank is on the cart 212, and the cart 212 is rolled on the wheels 258 across a bumpy or discontinuous surface, the weight applied to the load cell 214 can be far more than the static weight of the tank and/or more than the allowable weight that the load cell is designed to withstand, which could also damage the load cell 214. The lower support member 277 can provide a physical interference that limits the amount of load and/or deflection that can be applied to the load cell 214, thereby reducing or avoiding the chance of damage to the load cell 214 while still enabling the cart 212 to be readily moved on the wheels 258. In various embodiments, the cart 212 and/or load cell 214 does not need to be bolted down, or otherwise permanently secured, to a stationary floor. In some embodiments, the overload weight (e.g., the weight at which the overload protection engages) comprises at least about: 600 pounds, 800 pounds, 1,000 pounds, 1,500 pounds, 2,000 pounds, or more. In some embodiments, the base plate 250 and/or the tank support 255 comprise a stop, such as a block, fin, boss, flange, or otherwise. The stop can present a physical interference that limits the amount of travel of the tank support 255 relative to the base plate 250 and/or the amount of deflection of the cantilevered member 217. In some embodiments, the stop is positioned on an upper surface of the base plate 250. In certain variants, the stop is positioned on a lower surface of the tank support 255.

### Reporting System

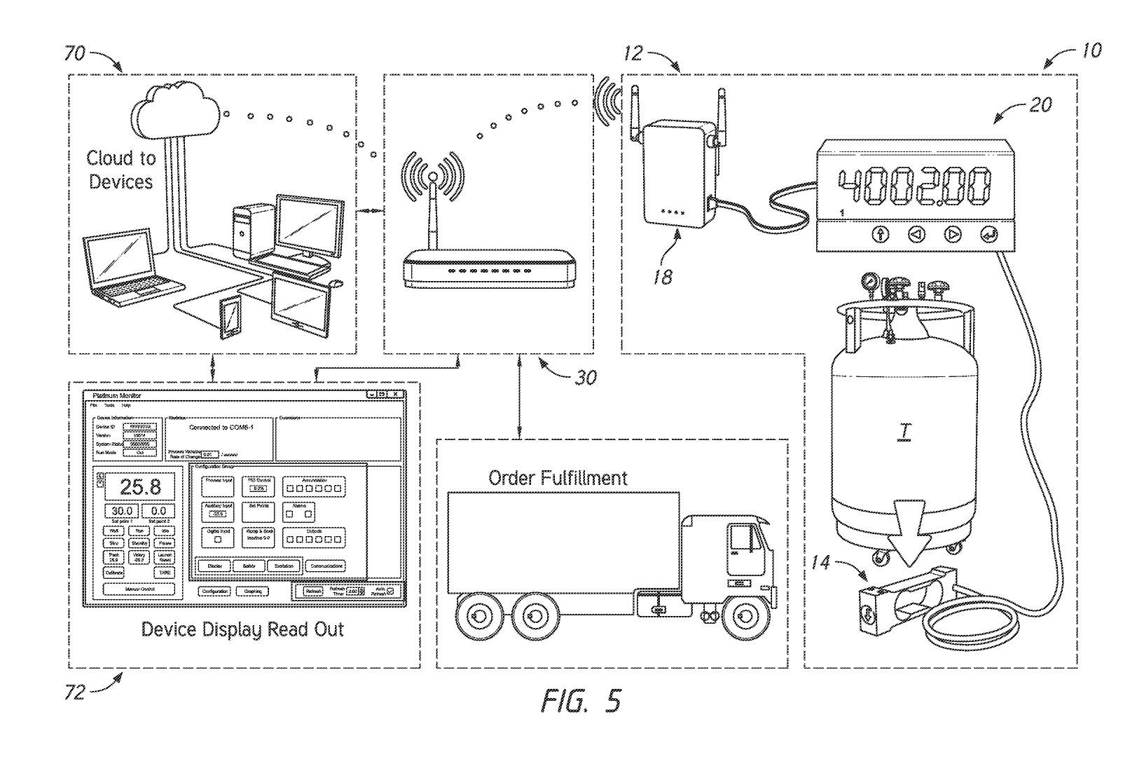

FIG. 5 schematically illustrates further features of certain embodiments of the cryogenic fluid reporting system 10. For purposes of presentation, the following discussion refers to the system with the cart 12, but is equally applicable to the carts 112, 212. In various embodiments, the system 10 is configured to automatically perform any of the features described herein (e.g., without first requiring an instruction from a human to proceed).

As mentioned above, in some embodiments, the tank's weight is applied to the load cell 14 on the cart 12. The load cell 14 can measure the weight of the tank. The load cell 14 can output a signal indicative of the weight of the tank. In some embodiments, the signal is received by the controller 16. The controller 16 can output a signal to the indicator 20 (e.g., a meter display) that displays the tank weight and/or volume of fluid in the tank. In various embodiments, the weight of the tank can be used to calculate the volume of cryogenic fluid in the tank. For example, volume can be determined by the equation V=wg/p, where V is volume, w is weight, g is the gravitational constant, and p is the density of the cryogenic fluid. In some embodiments, the cart 12 determines the volume. In some embodiments, the control unit 30 determines the volume. The tare weight of the tank can be subtracted from the detected weight of the tank. A memory (e.g., a memory of the controller 16 and/or of the control unit 30) can store the density and tare weight data.

In some embodiments, the communication unit 18, such as a transmitter or transceiver, transmits data related to the tank and/or the cart 12. For example, the data can be indicative of the tank weight or other data (e.g., time, date, amount of tank volume remaining and/or used, etc.). The data can be transmitted as packets. In some embodiments, the transmission occurs over the internet. In some embodiments, the tank's controller 16 can communicate, via the communication unit 18, directly with a remote computing device, such as a user's smart phone, laptop, or otherwise. This can enable a user to receive information from the computing system (e.g., the amount of liquid in the tank) and/or to change parameters of the cart (e.g., reporting durations). In some embodiments, the communication unit 18 is configured to receive updates to firmware or other kinds of software.

In certain embodiments, the communication unit 40 of the control unit 30 can receive the data transmission from the communication unit 18 of the cart 12. The data can be provided to a computing device of the control unit 30. For example, the control unit 30 can comprise a server and the data can be provided to the server. The data can be tabulated, analyzed, and/or stored, such as in the storage system 42 and/or by the control unit 30. The control unit 30 can receive data from the multiple carts 12, each of which hold one of the tanks. The data can include, for example, tank weight, tank volume, amount of liquid remaining in the tank, geographical location of customer, etc. The control unit 30 can receive other data, such as delivery data. For example, the control unit 30 can receive data related to available trucks, available drivers, truck and/or driver locations, etc. In some variants, the cart 12 communicates data readings to the control unit 30 periodically, such as in periods of less than or equal to about: 1 hour, 30 minutes, 15 minutes, 10 minutes, 5 minutes, 2 minutes, or less.

As FIG. 5 schematically illustrates, the control unit 30 can communicate with external computing devices 70, such as laptop or desktop computers, smartphones, tablets, etc. In some embodiments, the communication occurs over the internet or cloud. The communication can be wired or wireless (e.g., through a wi-fi network). In some embodiment, the communication, cell phone network, or otherwise includes data related to the system, the tank, and/or the cryogenic fluid. The control unit 30 can act as a server for the client computing devices 70. For example, the control unit 30 can respond to requests from, and/or provide data and instructions to, the computing devices 70, such as to provide graphical user interfaces, as described in more detail below.

The communication from the control unit 30 to the external computing devices 70 can include information related to the system 10, the tank, and/or the cart 12. For example, the communication can include data related to the tank weight, amount of remaining cryogenic liquid remaining in the tank, estimated duration until the tank is empty, etc. The external computing devices 70 can present such information on a display 72. In some embodiments, the control unit 30 displays information on a display 72, such as to staff operating the control unit 30. The control unit 30 can receive communications from the external computing devices 70, such as a request for a delivery (e.g., refilling of a cryogenic tank), an inventory check (e.g., a request for the control unit 30 to remotely assess whether a given cryogenic tank needs to be refilled), or otherwise.

In some variants, the display 72 comprises a web application. The web application can enable a user to view the amount of fluid in the user's tank. The application can be customized to display various data, such as the amount of liquid currently in the tank, how much has been used over a selected past time period, an average of the rate of usage over a selected past time period, and/or a prediction of how much will be used over a selected future time period. The application can display data from various locations (e.g., multiple cryogenic ice cream shops) to help the user compare usage between the different locations.

The system 10 can include programming to alert when the weight of the tank approaches or decreases below a set amount, such as less than or equal to about 20% volume remaining, 10% volume remaining, or otherwise. The display 72 can visually and/or audibly indicate the alert. In response to the alert, the system 10 can issue an instruction to refill the tank, can send a message (e.g., an email, text message, or otherwise) to the tank user, or can schedule a time and date for the tank to be refilled. For example, the system 10 can issue a message to a scheduler or truck driver to route a delivery truck to the location of the tank to be refilled.

The system 10 can provide a substantially real-time reporting of the amount (e.g., weight and/or volume) of cryogenic fluid in the tank, such as to the external computing devices 70. In some embodiments, the system 10 is accurate enough to determine and can provide the amount of cryogenic fluid in the tank within one decimal place. The data can be provided (e.g., wirelessly) to the external computing device 70, such as to a user's smartphone. The data can be displayed in an application, such as an application that can be downloaded by a user and accessed at any time. The application can indicate to the user status related to the system, the tank, and/or the cryogenic fluid. For example, the application can indicate the amount of cryogenic fluid in the tank. In some embodiments, the application can be used to calibrate parts of the cart, such as the load cell. In some implementations, the device executing the application (e.g., a smartphone or tablet) can be connected to the cart 12 with a wireless or wired (e.g., USB) connection.

In various embodiments, the control unit 30 is configured to analyze the data received from the carts 12. As an example, the control unit 30 can monitor and compare the amount of cryogenic fluid that is used for a procedure, such as a cryotherapy session, the making of a serving of cryogenic ice cream, etc. The control unit 30 can track how that amount of used fluid changes based on different parameters, such as the time of day, day of the week, month of the year, whether the day was a holiday, the weather at the location of use, the user, the type of procedure (e.g., a small or a large ice cream), or otherwise. The control unit 30 can identify those procedures that use more or less of the cryogenic fluid and correlate such use with the parameters. This can identify waste or inefficiencies. For example, certain users may unconsciously use more cryogenic fluid during a cryotherapy session or making a serving of cryogenic ice cream on a hot day than on a cold day. The control unit 30 can identify such usage so that the user can be trained and the inefficiency corrected.

As further illustrated in FIG. 5, the control unit 30 can communicate with an order fulfillment unit, such as a delivery truck. For example, in some embodiments, control unit 30 can communicate with a smartphone of the truck driver. The control unit 30 can provide scheduling instructions, such as the time and location of a delivery (e.g., refilling of a cryogenic tank). The control unit 30 can receive communications in return, such as a confirmation that the delivery was completed. Certain embodiments of the system 10 are configured to perform automatic scheduling. Scheduling (e.g., timing, routing, etc.) of tank delivery trucks in a timely and efficient manner, while also accommodating customer needs, is highly complex and difficult. Improper scheduling could result in inefficient deliveries, unhappy customers, and/or improper determination of cost metrics on a per-delivery basis. The delivery scheduling can be impacted and/or limited by, for example, work day limits (e.g., 8 AM-6 PM), customer requests, refill tank volume, geography, etc. In some embodiments, the scheduling is averaged over a time period (e.g., month) instead of being solely focused on a single, individual delivery. In some embodiments, the control unit 30 can determine an estimated time at which a given a cryogenic tank will be empty (e.g., based on historical usage of the tank). In certain implementations, the control unit 30 automatically schedules a delivery so that the tank is refilled before the estimated time occurs.

As mentioned above, the control unit 30 can interface with the storage system 42. The storage system 42 can include a database of information, such as delivery dates, delivery times, delivery time duration at each customer, distance and/or time duration to next delivery location, duration of the relationship with the customer, delivery amounts, delivery fluid types (e.g., liquid nitrogen, liquid oxygen, etc.), customer locations, customer requests (e.g., appointment times and dates), customer fluid type, other customers in a specified vicinity, and/or other data. The system 10 can access the database and can determine, based on the data in the database, various instructions and/or recommendations, such as an efficient route and/or schedule for a truck. In some embodiments, the system 10 can determine that a given delivery should take a certain amount of time based on an average duration of a plurality (e.g., at least about 5, 10, or more) past deliveries to that customer. Thus, the system 10 can estimate the approximate duration of a future delivery to that customer, and can use such an estimate in determining the schedule. The system 10 can also estimate the amount of time required to reach the next delivery location based on the past delivery data.

The system 10 can receive inputs, such as customer name, customer account, customer location, customer fluid type, requested appointment time and date, etc. The system 10 can determine a schedule that accommodates such requests, based on the past data in the database. Certain embodiments provide cost modeling, sensitivity analysis, scaling for growth, and/or additional efficiencies (e.g., invoicing, operations/driver communication, customer-reporting, of levels, etc.). Certain embodiments of the system include a sensitivity analysis combined with Monte Carlo type simulations to determine the schedule.

The system 10 can be linked to other manufactured products in order to send data to, and/or receive data from, such other products. This can enable the other products to display and/or use data from the cart 12 of the system 10. For example, a cryotherapy device can receive fluid usage data from the cart 12, which can enable the cryotherapy device to determine the amount (e.g., volume) of liquid nitrogen it takes to run one session. This can provide feedback to the user, can help users gain further economy, and can have less waste. As another example, the cart 12 can communicate with liquid nitrogen freezers. This data can be used to display the data, set alarms for low levels, monitor how much liquid nitrogen is being consumed, and/or make predictions about future ordering.

In some embodiments, an indicator (such as a button, switch, or otherwise) is installed on or near a machine that receives fluid from the tank on the cart 12. For example, a button can be positioned on a cryogenic ice cream machine that is connected with the tank. The button can be wired or wireless and can send a signal to the cart 12 in response to being actuated. When a user begins to make an ice cream, the user pushes the button to signal the cart 12 to take a measurement of the amount of fluid (e.g., liquid nitrogen) in the tank. When the user is done making the ice cream, the user pushes the button again to signal the cart 12 to take another measurement of the amount of fluid in the tank (e.g., due to the change in weight). The difference in the amount of fluid can be tracked and logged to gain understanding as to how much fluid it takes to make one serving, the amount of fluid used by various users, etc. This can enable forecasting of when the fluid in the tank will be used up and/or for performance evaluations. In some embodiments, the data related to the usage of the fluid used is saved, such as in a non-transitory storage system (e.g., the database 42). In some variants, the amount of cryogenic fluid used during the procedure can be compared, such as to a setpoint amount, goal amount, median use amount, or otherwise.

In various embodiments, the system 10 can determine the normal evaporation rate (NER) of the tank. NER is the amount of product loss in a cryogenic liquid container due to heat leak into the container. Because each tank is slightly different, the NER can differ from tank to tank. Moreover, the NER changes based on the level of product in the tank and the condition of the tank. Monitoring the NER can allow the user to quantify how much loss is occurring from the tank itself, to identify that the tank is defective or damaged (e.g., because of an unusually high NER), and/or to decide to replace the tank with a different tank having a lower NER. In some embodiments, the system 10 determines NER based solely or partially on the change of the weight of the tank over time. For example, the NER can be calculated from the change in tank weight over a 24-hour period. In some embodiments, the control unit 30 determines the NER. In certain variants, the cart 12 determines the NER. Certain embodiments measure the tank weight and/or determine the NER continuously, such as less than or equal to about every 1 second. Some variants measure the tank weight and/or determine the NER or periodically, such as at least about every: 5 minutes, 10 minutes, 15 minutes, 30 minutes, 1 hour, or otherwise. In some embodiments, the system 10 receives tank weight and/or NER data about the tank numerous times per day. This information can be stored and calculated to determine the NER for the tank. Some implementations of the system 10 detect at least 144 tank weight readings per day and use those readings to determine at least 144 NER values, which can be charted compared to time. In various embodiments, the NER can be provided to the external computing devices 70 (e.g., of the tank supplier and/or the tank user), such as on a graph and/or in a graphical user interface of a computer application. The NER can be used to assess whether a given tank is wasting product due to heat leak, such as because the container is damaged or not working as designed. In some embodiments, NER is calculated locally, such as by the cart 12. In certain variants, the NER is determined remotely, such as by the control unit 30. In some implementations, the NER of the tank is compared to other data. For example, the NER of the tank can be compared to a median NER and/or average NER, which can be determined from a plurality of tank NERs. In some implementations, the NER of the tank is compared to a limit. The limit can be an upper acceptable NER, such as at least about 3% of the capacity of the tank. In some embodiments, in response the NER of the tank being greater than or equal to the limit, an alert is issued. For example, the control unit 30 can mark the tank as defective, such as by adding a software flag to the data for that tank in the storage system 42. The tank can be replaced when a technician next visits the location of the tank. In several embodiments, the system 10 acts automatically. For example, the system 10 can automatically determine the NER, provide the NER to external computing devices, and/or the compare the NER to other data.

In various embodiments, the NER of the tank can be continuously monitored. NER testing typically requires removing the tank from a location of use and conducting cumbersome and lengthy testing, such as for at least 24 to 48 hours. See, for example, U.S. Pat. No. 6,898,985, the entirety of which is hereby incorporated by reference. The system 10 can determine a NER for a tank at the location of use and/or without the need to transport to an off-site testing facility. The system 10 can determine a NER for a tank generally continuously and/or in real time. The NER can be determined based on the change of weight over time. In some embodiments, the system is configured to not determine a NER for tanks that are in active operation, since such a change in weight is mainly attributable to the normal use of the cryogenic fluid and not to loss due to heat leakage into the tank. For example, in some variants, the system 10 does not determine a NER for any tank in which consecutive weight readings differ by at least about: 0.5 pounds, 1 pound, 2 pounds, 3 pounds, or more. In some variants, the readings are spaced apart by less than or equal to about: 15 minutes, 10 minutes, 5 minutes, or less.

The system 10 can use tank weight and/or NER in various ways. For example, the system 10 can detect an abrupt change in tank weight and/or NER (e.g., at least about a 10% change), which could indicate a situation that the tank user should investigate. For example, an abrupt change in tank weight and/or NER may indicate that the tank has been moved or impacted, which may warrant investigation. The system 10 can issue an alert to the user in response to an abrupt change in tank weight and/or NER. In some embodiments, the system 10 can determine, and issue an alert, in response to the NER rising to or above a certain value and/or the tank weight falling to or below a certain value. For example, if the NER exceeds a certain value that could indicate that the tank's thermal insulating features have been compromised. If the tank weight falls below a certain value that could indicate the tank is almost empty.

Various embodiments of the system 10 are configured to enable the tank to remain onsite at a user's facility, rather than being exchanged with a different tank. Some embodiments of the present disclosure include a method of refilling the tank at the location of use and/or not at a central filling facility. Some embodiments include maintaining the same tank for the same user and/or not swapping the tank for a different tank. Various embodiments do not include transporting the tank on a road during the process of providing the user with a filled cylinder. Some implementations include a delivery vehicle that travels to a user's location in order to fill the user's tank at the user's facility. Filling the tank onsite can enable the tank to be filled more completely, since the tank is not being transported over roads and highways, which can limit the allowable fill level. Also, filling the tank onsite can avoid wear and tear on the tank that is customary with removing a tank from a facility, transporting the tank to an offsite filling location, and then reinstalling the tank in the same or a different facility. Moreover, by refilling the tank onsite, the user is able to keep the same tank. This can be desirable for certain cryogenic liquid users who get used to their tank and its characteristics. Further, by the tank remaining onsite, stickers, labels, and apparatuses that the users put on the tank can be allowed to remain in place.

Some embodiments are used in the microbulk delivery sector. Microbulk tanks can use telemetry which takes a measurement of the inches of liquid (e.g., water) of large tanks, such as tanks with a volume of about 1,000 liters, 2000 liters, 3000 liters, 9,000 gallons, or otherwise. This information can be wirelessly sent to a central server, such as once per day (or more frequently), via a cell phone signal. Some implementations include a scale beneath the microbulk tank to weigh the contents.

### Delivery Vehicle

Certain embodiments include a vehicle 80, such as a truck. The truck 80 can comprise a large refilling tank RT that travels to a user's location to fill the user's tank at the user's facility. The refilling tank can comprise a volume that is greater than the volume of a standard cryogenic cylinder, such as at least about 500 liters. In some embodiments, the truck 80 can communicate with the cart 12 and/or the control unit 30, such as with a wired or wireless connection. In some embodiments, the tank 12 can communicate pre- and post-filling weight of the tank to the control unit 30 of the system 10, such as after the tank refilling process has been completed. Such a data transfer can be initiated by a user or a driver of the truck activating a button or other actuator on the cart 12 and/or the truck 80. The data can be logged by the control unit 30 and certified. The data can be transferred to accounting software and/or used to generate a receipt, invoice, etc. The data can be sent to the customer, such as via text or email. The data can be specific to the contents of each individual tank, as well as collectively with other tanks.

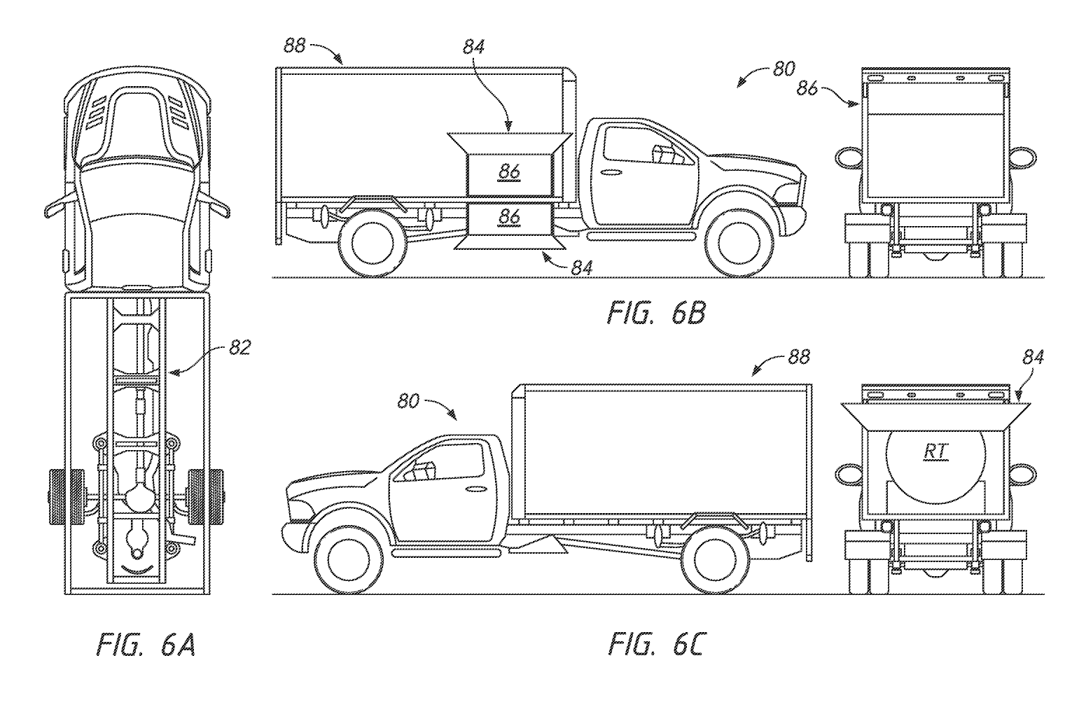

An example cryogenic fluid delivery truck 80 is shown in FIGS. 6A-6C. The truck 80 can include a support mechanism 82 for adapting a vehicle (e.g., a pick-up or other type of truck) to carry cryogenic cylinders. The support mechanism 82 can provide structural support and strength to bear the substantial weight of the refill tank RT. The truck 80 can go to a location where a cryogenic cylinder is being used in order to refill the cryogenic cylinder without needing to remove the cryogenic cylinder from its location. In some embodiments, the truck 80 includes doors 84 on the rear and/or sides of the truck. The doors can allow access to the refill tank RT and/or to storage compartments 86. The storage compartments 86 can comprise hoses and fittings for fluidly connecting the refill tank RT with the tank to be refilled. The truck can include a housing 88 that protects the refill tank RT.

### Graphical User Interfaces

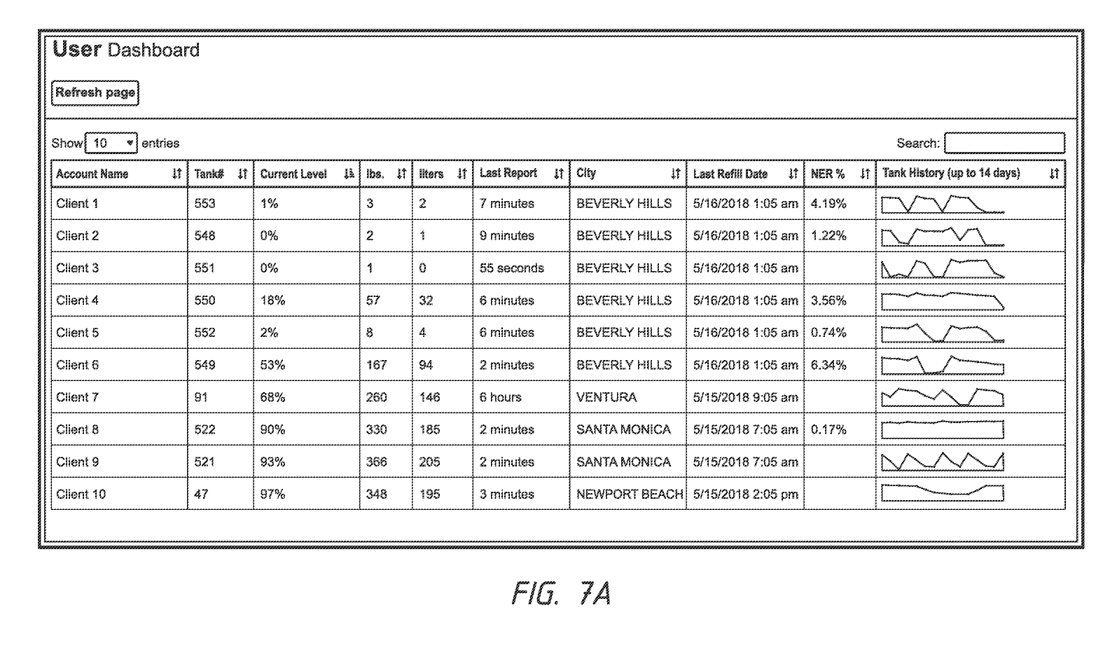

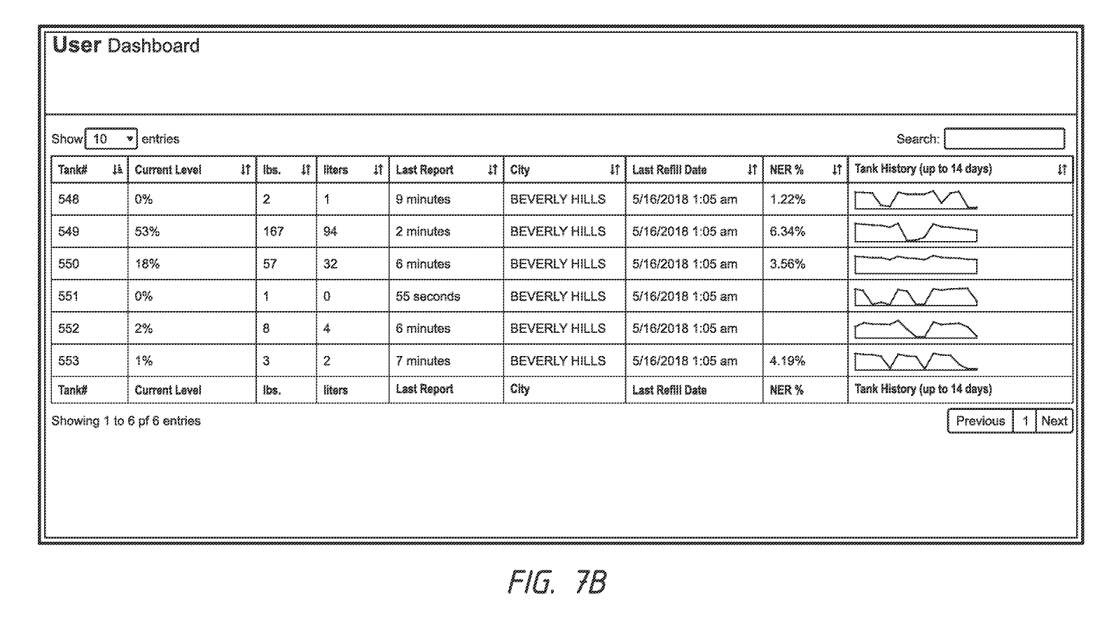

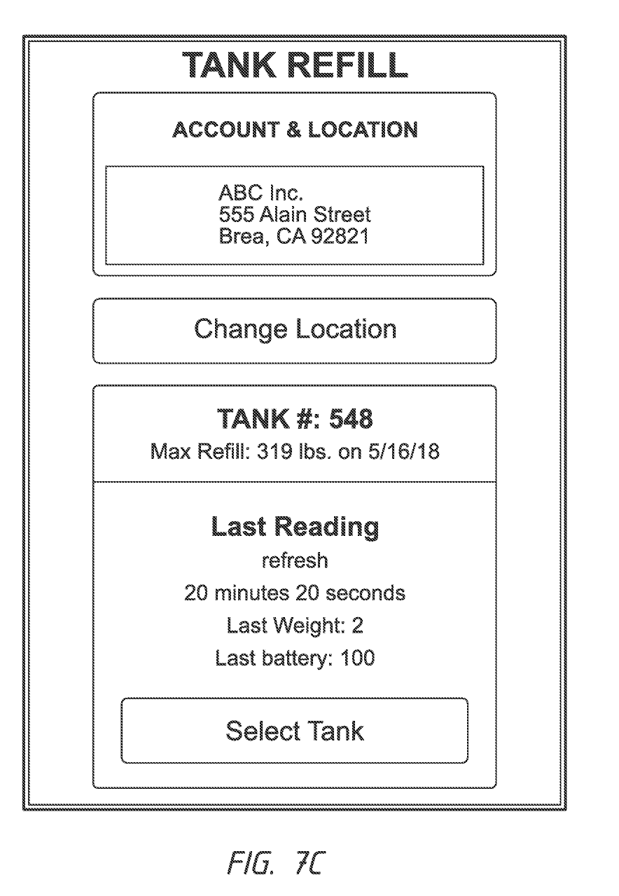

FIGS. 7A-7C illustrate example graphical user interfaces that can be implemented with the system 10. The graphical user interfaces can be accessed via a desktop or laptop computer, smartphone, tablet, or other computing device. In some embodiments, the graphical user interfaces are accessed via web application and/or through a web browser. The graphical user interfaces can display data about the tanks, which are positioned on respective carts 12. As discussed above, each cart 12 can report data about its respective tank to the control unit 30. The control unit 30 can store, tabulate, and/or analyze the data. The control unit 30 can act as a server. For example, the control unit 30 can receive data requests from various computing devices can provide data and/or instructions to the computing devices to enable the graphical user interfaces to be displayed.

FIG. 7A illustrates an example of a dashboard for a central processing facility. The central processing facility can be, for example, a facility that includes the control unit 30. In some embodiments, the central processing facility schedules, dispatches, and/or is home to the trucks that travel to the tanks to refill the tanks. As shown, the dashboard can display various information about various cryogenic tanks, which are positioned on carts that are reporting information about their respective tanks to the control unit 30. For example, as illustrated, the dashboard can display the account or customer's name, a number or other unique identifier for each tank, the current level (e.g., by percentage of volume) for each tank, the weight and/or amount (e.g., liters, gallons, etc.) of each tank. The time of and/or duration since the cart on which the tank reported information can be displayed. The location (e.g., city) of the tank can be displayed. In some embodiments, the dashboard can display the time of and/or duration since the tank was refilled or otherwise serviced. The dashboard can display the NER for a tank. If the NER exceeds a limit (e.g., 3%), an alert can be issued, such as by the displayed NER changing color (e.g., to red). In some implementations, the dashboard includes a graphical representation of historical data related to the tank, such as a chart of tank weight, tank volume, tank percentage full, tank NER, or otherwise. In some embodiments, the historical data is shown for 7 days, 10 days, 14 days, 1 month, or otherwise.

FIG. 7B illustrates an example of a dashboard for an end user, such as a user at the facility at which the tank and cart 12 are located. The dashboard of FIG. 7B can include any of the information discussed above in connection with FIG. 7A. However, because the dashboard of FIG. 7B can already be specific to a certain customer, some embodiments do not include a column listing the account or customer's name.

FIG. 7C illustrates an example of a dashboard for a technician, such as a driver sent to refill a tank. In some embodiments, the dashboard is displayed on a touchscreen device, such as a smartphone. As illustrated, the dashboard can include a customer's account information (e.g., address) and functionality (e.g., a button) to enable the user to change the location. The dashboard can include information about the tank to be refilled, such as the tank's number or other unique identifier, historical information (e.g., the maximum refill amount and date), etc. The dashboard can display the latest information received by the control unit 30 about the tank, such as the time since the last reading, the last weight, and the last battery level (e.g., percentage full). The dashboard can include functionality (e.g., a button) to enable the user to change to a different tank. In some embodiments, the dashboard can display whether the tank has been flagged as defective, such as due to having a NER above a limit amount.

### Certain Terminology

Terms of orientation used herein, such as “top,” “bottom,” “proximal,” “distal,” “longitudinal,” “lateral,” and “end,” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular,” “cylindrical,” “semi-circular,” or “semi-cylindrical” or any related or similar terms, are not required to conform strictly to the mathematical definitions of circles or cylinders or other structures, but can encompass structures that are reasonably close approximations. Terms relating to volume, such as “filled” or “refilled,” do not require that a volume be completely full (e.g., at least 90% full). For example, a tank that is that substantially full can be said to be filled.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may dictate, the terms “approximately,” “about,” and “substantially,” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may dictate, the term “generally parallel” can refer to something that departs from exactly parallel by less than or equal to 20 degrees.

### Summary

Various cryogenic fluid reporting systems have been disclosed in the context of certain embodiments and examples. This disclosure extends beyond the specifically disclosed embodiments to other alternative embodiments and/or uses of the embodiments and certain modifications and equivalents thereof. Use with any structure is expressly within the scope of this invention. Various features and aspects of the disclosed embodiments can be combined with or substituted for one another in order to form varying modes of the assembly. The scope of this disclosure should not be limited by the particular disclosed embodiments described herein.

Certain features that are described in this disclosure in the context of separate implementations or embodiments can also be implemented in combination in a single implementation or embodiment. Conversely, various features that are described in the context of a single implementation or embodiment can also be implemented in multiple implementations or embodiments separately or in any suitable subcombination. Moreover, although features may be described above as acting in certain combinations, one or more features from a claimed combination can, in some cases, be excised from the combination, and the combination may be claimed as any subcombination or variation of any subcombination.

Some embodiments have been described in connection with the accompanying drawings. The figures may be to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

In summary, various embodiments and examples of cryogenic fluid reporting systems have been disclosed. Although these have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow.

The following is claimed:

1. A portable cart configured to determine and report an amount of cryogenic liquid in a cryogenic fluid tank, the portable cart comprising:
a tank support configured to receive and support the cryogenic fluid tank;
a frame comprising a base plate and a plurality of caster wheels;
a plurality of load cells positioned between the tank support and the frame, the cart configured such that the weight of the cryogenic fluid tank on the tank support is applied to the plurality of load cells;
wherein at least one of the plurality of load cells comprises an overload protected load cell, the overload protected load cell comprising:
an upper member configured to contact the tank support; and
a lower member that is spaced apart from the base plate by a gap when no weight is applied to the overload protected load cell;
the overload protected load cell being configured such that, in response to an overload of weight being applied to the overload protected load cell, the overload protected load cell deflects such that the lower member contacts the base plate;
a controller in communication with the plurality of load cells, the controller configured to receive a signal from each of the load cells indicative of the weight of the cryogenic fluid tank and to determine, based on the signals, an amount of cryogenic liquid in the cryogenic fluid tank; and
a transmitter in communication with the controller.

2. The portable cart of claim 1, wherein the overload protected load cell further comprises a deflectable cantilevered member that is connected with the upper member and the lower member.

3. The portable cart of claim 1, wherein the upper member comprises a generally hemispherical upper end.

4. The portable cart of claim 1, wherein the frame further comprises a plurality of legs, each of the plurality of legs comprising one of the plurality of load cells.

5. The portable cart of claim 1, wherein the plurality of caster wheels are positioned radially outward of the base plate.

6. The portable cart of claim 1, further comprising a battery configured to supply electric power to the controller.

7. The portable cart of claim 1, further comprising a removable handle.

8. A system for monitoring the normal evaporation rate (NER) of a cryogenic fluid tank, the system comprising:
a load cell configured to determine a weight of the cryogenic fluid tank; and
a computing system programmed to:
determine, based on the weight of the cryogenic fluid tank, the volume of fluid in the cryogenic fluid tank;
determine a NER of the cryogenic fluid tank; and
issue an alert in response to the NER being greater than or equal to a NER limit value.

9. The system of claim 8, wherein the alert comprises a flag in a database of the computing system, the database comprising data about the cryogenic fluid tank.

10. The system of claim 8, wherein the computing system is programmed to determine the NER of the cryogenic fluid tank based on a change of the weight of the tank over time.

11. The system of claim 8, wherein the computing system is further programmed to:
determine a median NER value from a plurality cryogenic fluid tanks; and
compare the NER of the cryogenic fluid tank with the median NER value.

12. The system of claim 8, wherein the computing system is further programmed to:
determine a NER change value of the cryogenic fluid tank, the NER change value being the change of the NER of the cryogenic fluid tank over a predetermined period; and
issue a change alert in response to the NER change value being greater than or equal to a NER change limit value.

13. The system of claim 8, wherein the computing system is further programmed to receive, from a smartphone app, a change to the NER limit value.

14. A method of monitoring cryogenic fluid usage, the method comprising:
measuring, with a load cell, a first weight of a cryogenic fluid tank comprising a cryogenic fluid;
receiving a start signal indicating the start of a procedure that uses the cryogenic fluid;
receiving an end signal indicating the end of the procedure that uses the cryogenic fluid;
measuring, with the load cell, a second weight of the cryogenic fluid tank;
determining, with an electronic processor and based on the difference between the first and second weights, the amount of cryogenic fluid used during the procedure; and
displaying, on a graphical user interface, the amount of cryogenic fluid used during the procedure.

15. The method of claim 14, wherein receiving the start signal comprises receiving a first signal from a button, and wherein receiving the stop signal comprises receiving a second signal from the button.

16. The method of claim 14, further comprising receiving the cryogenic fluid tank on a portable cart comprising the load cell and a plurality of wheels.

17. The method of claim 14, further comprising interfacing the electronic processor with a machine that performs the procedure that uses the cryogenic fluid.

18. The method of claim 14, wherein the procedure comprises a cryotherapy procedure.

19. The method of claim 14, further comprising storing data indicating the amount of cryogenic fluid used during the procedure in a non-transitory storage.

20. The method of claim 14, further comprising comparing the amount of cryogenic fluid used during the procedure to a setpoint amount.
